(19) United States
(12) Patent Application Publication
(10) Pub. No.: US 2016/0184963 A1
(43) Pub. Date: Jun. 30, 2016

(54) DUST SHROUD WITH INTERNAL IMPELLER AND ADJUSTABLE MOUNTING MECHANISM

(71) Applicant: DUSTLESS DEPOT, LLC, Price, UT (US)

(72) Inventor: Randy Melancon, Price, UT (US)

(21) Appl. No.: 14/972,078

(22) Filed: Dec. 16, 2015

Related U.S. Application Data
(60) Provisional application No. 62/092,736, filed on Dec. 16, 2014.

(51) Int. Cl. B24B 55/10; B01D 45/08

(52) U.S. Cl. CPC B24B 55/102; B01D 45/08

(57) ABSTRACT

A dust collection system includes a dust shroud with an internal impeller and a restrictor plate which separates the impeller from a cutting attachment. The impeller and restrictor plate provide air flow from the cutting attachment, through the shroud, and out of an exhaust port such that the dust collection system may be used without a powered filter if desired. The dust shroud may include an attachment to an angle grinder with clamping arms pivotably attached to the top of the dust shroud body. The clamping arms move inwardly relative to the shroud body to accommodate different sizes of angle grinders.

### RELATED APPLICATIONS

The present application claims the benefit of U.S. Provisional Application Ser. No. 62/092,736, filed Dec. 16, 2014, which is hereby incorporated herein in its entirety.

### THE FIELD OF THE INVENTION

The present invention relates to dust collection. In particular, examples of the present invention relates to a dust collection system for tools such as an angle grinder.

### BACKGROUND

Dust collection has become increasingly important both for commercial use and construction as well as for consumer or hobbyist use of power tools. Without adequate dust collection while working, dust and debris is typically scattered over a wide area. It is desirable to contain the dust and debris which is created while using power tools for several reasons. It is desirable to contain the dust and debris to keep the workplace cleaner and to minimize the time necessary to clean up afterwards. For example, angle grinders are often used to cut or grind cement. Grinding materials such as cement creates fine dust which is spread over a large distance and can be quite difficult to clean up afterwards. It is also desirable to contain the dust and debris to keep the debris from getting into the tool itself, as the fine dust often causes premature failure of the tool bearings, motor, etc. Additionally, dust poses a health risk to the machine operator and others who may breathe it. It is thus desirable to collect the dust to minimize any exposure to the dust.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIGS. 1A through 2C are drawings which show exploded views of a dust collection system.

FIG. 3 is a drawing which shows a perspective view of the dust collection system.

FIG. 4 is a drawing which shows a top view of the dust collection system.

FIG. 5 is a drawing which shows a cross-sectional view of the dust collection system.

FIG. 6 is a drawing which shows a more detailed view of the clamping arms.

Corresponding reference characters indicate corresponding components throughout the several views of the drawings. Skilled artisans will appreciate that elements in the figures are illustrated for simplicity and clarity. The drawings have been drawn to scale to allow for understanding of the device. Common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art.

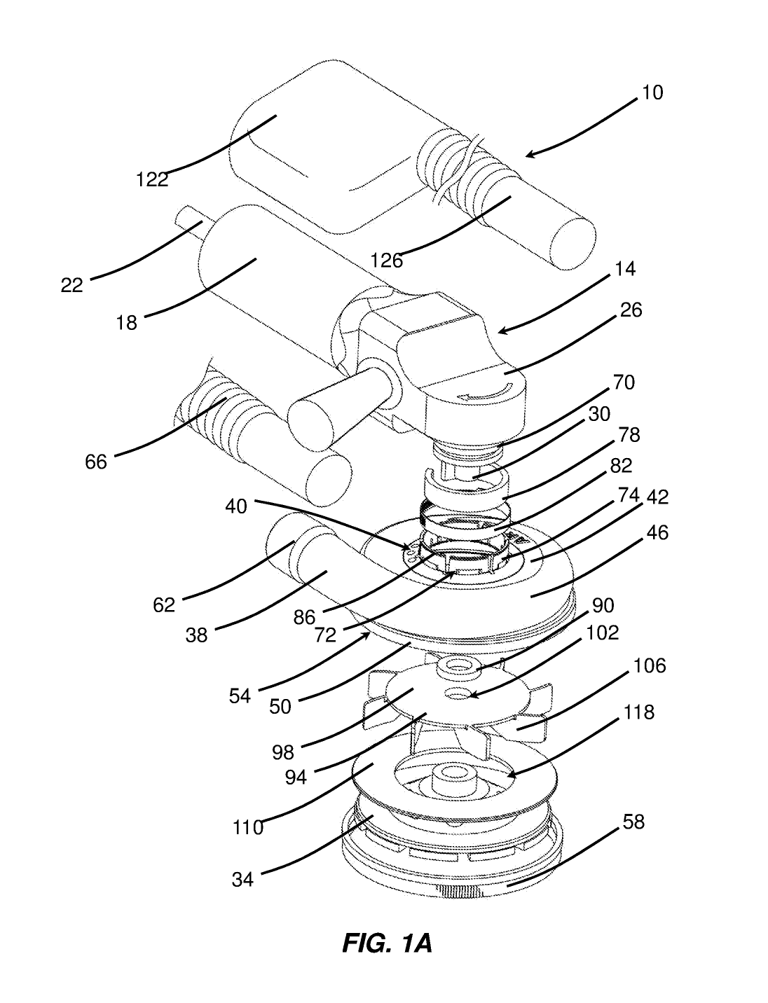

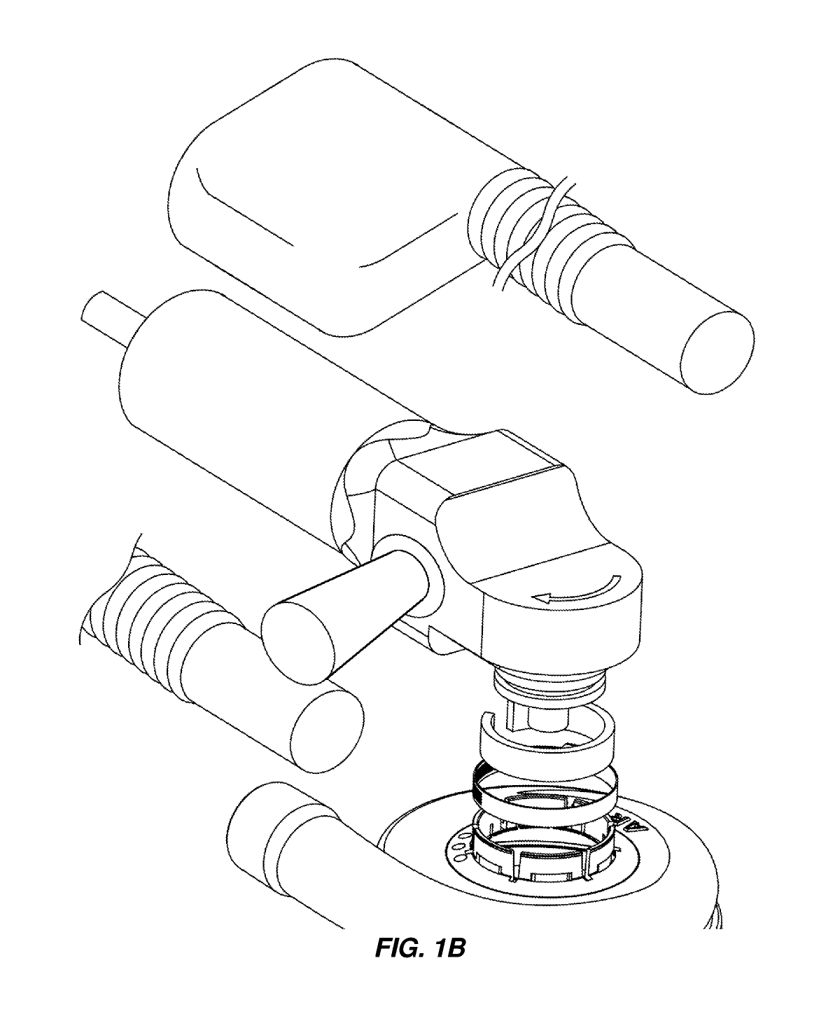

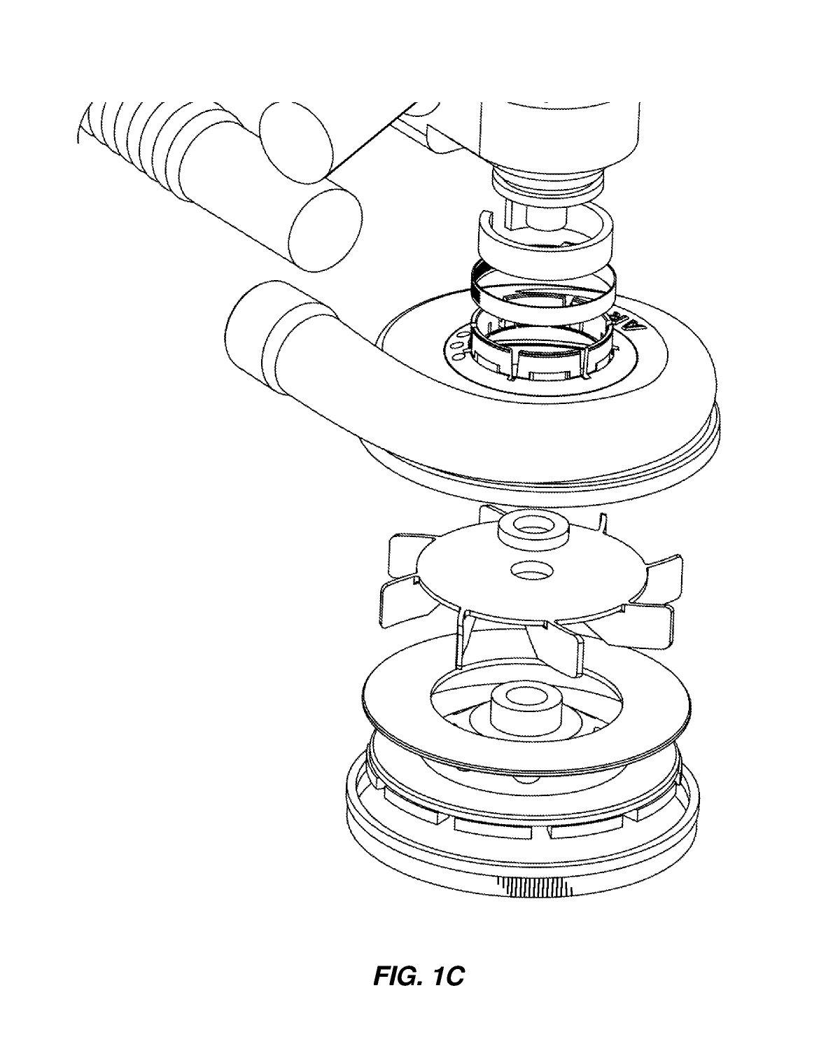

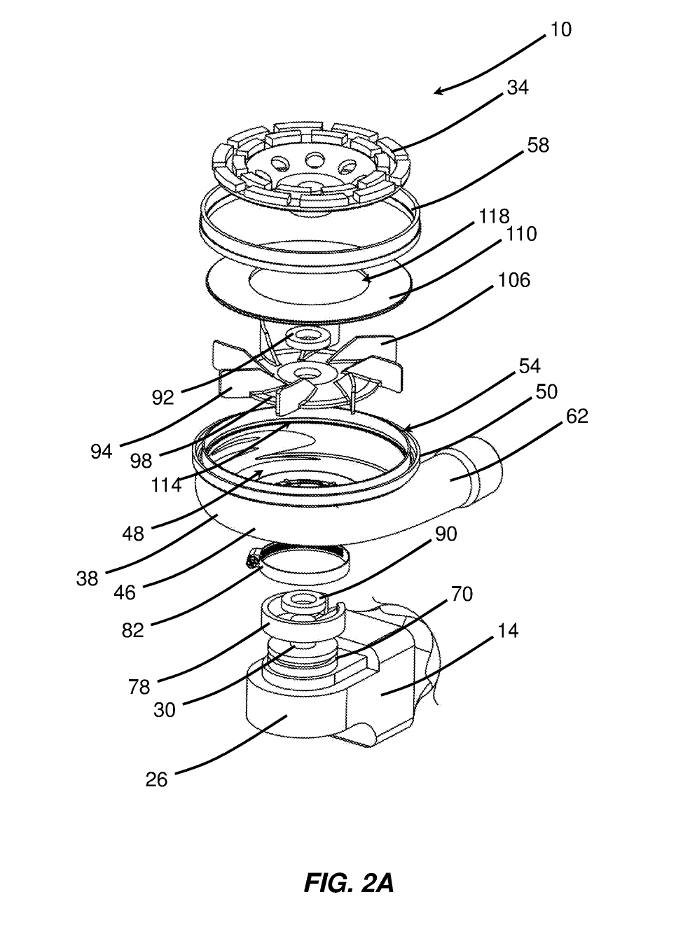

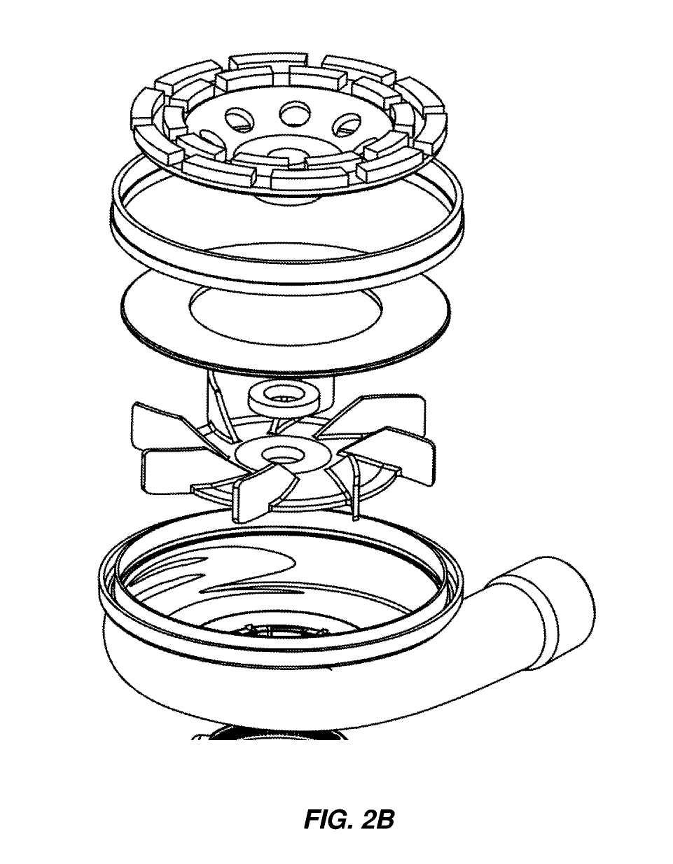

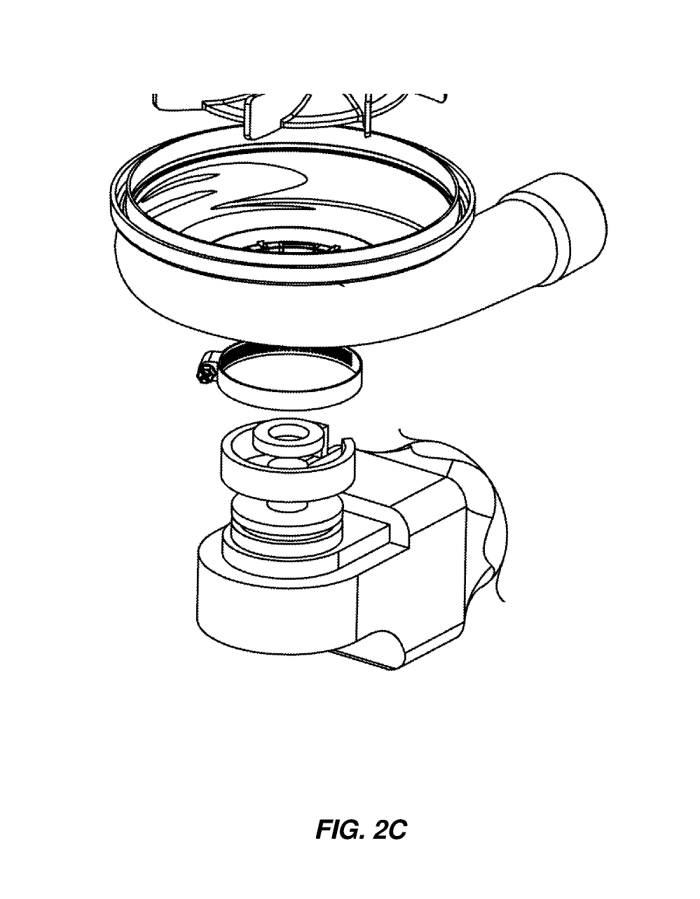

Referring now to FIGS. 1A through 2C, exploded views of a dust collection system is shown. FIGS. 1A through 1C show a top view of the dust collection system parts while FIGS. 2A through 2C show a bottom view of the dust collection system parts. The views of the dust collection system are shown in two figures to allow the parts to be shown in greater detail. The example dust collection system 10 is designed for operation with an angle grinder 14. Angle grinders 14 typically include a grinder body 18 which houses an electric motor and provides a structural support for much of the grinder 14. An electrical power cord 22, switch, etc. may be mounted to the grinder body 18. The angle grinder 14 includes a gearbox 26. The gearbox 26 is used to provide an appropriate output speed for the grinder and is also used to position the output shaft 30 at a 90 degree angle to the motor and body 18.

Angle grinders 14 are frequently used with sanding attachments or grinding cup wheels to sand or grind different materials. A diamond covered cup wheel 34 may be used to grind concrete and masonry. Sanding discs may be used to sand wood, plastics, or fiberglass. These grinding processes create a significant amount of dust, much of which is harmful to humans. Small particulate grinding dust from many different materials is harmful to the lungs and should be contained.

The dust collection system 10 is used to collect the grinding dust and capture the dust to reduce the environmental and health impact of using the angle grinder 14. The dust collection system includes a shroud 38 which is attachable to the angle grinder 14. The shroud 38 includes an upper surface 42 and a sidewall 46 which extends downwardly from the upper surface. The upper surface 42 and sidewall 46 form a dust collection chamber 48 which is generally enclosed and which has an open bottom. As shown, the sidewall 46 is generally round as viewed from above and may be formed with a curved transition between the sidewall and the upper surface 42. The bottom edge 50 of the sidewall 46 may be formed with a channel 54 (FIG. 2) that receives a skirt 58. The skirt 58 is flexible and often contacts the work surface which is being ground by the grinder to assist in collecting dust. The skirt 58 may be a flexible plastic or rubber. In this example, the skirt 58 is formed by a plurality of bristles held together in a crimped metal ring. The bristles form a generally continuous wall. The skirt 58 is round and encircles the dust collection chamber 48 along the lower edge 50 of the shroud sidewall 46. The skirt 58 is typically preinstalled into the channel 54.

The shroud 38 includes an exhaust port 62. The exhaust port 62 is attached to the upper surface 42 and sidewall 46 so that it is oriented tangentially to the outside of the cup wheel 34 and shroud 38. The exhaust port opens from the shroud body so that it flows smoothly from the shroud 38 and continues in the direction of rotation of the cup wheel 34. The exhaust port 62 has an interior bore or passage which is connected to the interior of the dust collection chamber 48 so that dust can move from the dust collection chamber 48 through the exhaust port 62. The shroud body 38 may also include one or more small holes 40 which create openings through the upper surface 42 of the shroud 38 adjacent the center of the shroud 38. These small holes 40 may allow a small amount of air to pass into the dust collection chamber 48 to cool the grinder output bearings and sweep debris away from the bearings as the air is carried towards the exhaust port 62. In some situations, the exhaust port 62 may be connected to a vacuum to extract dust from the dust shroud 38. The exhaust port 62 may thus be sized to receive a 1.25 inch vacuum hose 66 (or a larger hose for larger shrouds/grinders). In some situations, it may not be possible to use a vacuum in combination with the grinder 14 and a filter 122 or other collection device may be connected to the exhaust port 62 instead of a vacuum hose 66.

The shroud body 38 is attached to the angle grinder 14. Many angle grinders 14 include a round (cylindrical) shoulder 70 which extends downwardly from the gearbox 26 surrounding the grinder output shaft 30. The shoulder 70 may house bearings to support the output shaft 30. The upper surface 42 of the shroud body 38 has a hole therethrough. The hole through the upper surface 42 of the shroud body is typically located in the center of the upper surface of the shroud body. The output shaft 30 of the grinder 14 passes through the hole and into the dust collection chamber 48 so that the cup wheel 34 or other grinding attachment can be located in the dust collection chamber. The shroud body 38 may be formed with an attachment structure 72 attached to the upper surface 42. The attachment structure 72 may include a plurality of flexible tabs 74 which extend upwardly from the upper surface 42, forming a cylindrical collar. The flexible tabs 74 may have a cutout or a corrugated section near their attachment to the upper surface 42 of the shroud to allow the tabs 74 to move inwardly or outwardly as they are clamped against the grinder shoulder 70. If needed, a spacer or collar adapter 78 may be placed between the tabs 74 and the grinder shoulder 70, allowing the shroud body 38 to fit a number of different brands of angle grinders 14. A clamp 82 such as a worm drive clamp may be placed around the tabs 74 and used to secure the tabs 74 and adapter 78 to the shoulder 70. The tabs 74 may have a small ridge 86 at their top edge which keeps the tightened clamp 82 from slipping off of the tabs 74. The shroud body 38 is thus secured to the angle grinder 14.

In use, the shroud body 38 is usually first secured to the angle grinder 14 and the other remaining parts of the dust collection system are attached thereto. An impeller spacer 90 and impeller 94 may be placed over the grinder output shaft 30. The impeller spacer 90 is placed between the grinder gearbox 26 and the impeller 94 on the grinder output shaft 30. The impeller spacer 30 may be used to place the impeller 94 at a desired position along the grinder output shaft 30 so that the impeller 94 is positioned correctly relative to the shroud body 38. The impeller 94 includes a generally flat disk or plate 98 with a hole 102 in the center thereof. The hole 102 is a close sliding fit to the output shaft 30 of the grinder 14 so that the hole locates the impeller 94 on the output shaft 30. The diameter of the impeller plate 98 is approximately 75 percent of the overall diameter of the impeller 94, and may be between about 60 and 85 percent of the overall diameter of the impeller 94.

Blades 106 extend outwardly beyond the impeller plate 98. The blades 106 are attached to the bottom of the impeller plate 98 and extend downwardly from the impeller plate as well as outwardly from the impeller plate. Approximately the inner 65 percent of the width of the blades 106 is attached to the impeller plate and approximately the outer 35 percent of the width of the blades 106 extends beyond the impeller plate 98. In different examples, between approximately one half and three fourths of the impeller blades 106 may be attached to the impeller plate 98 while between approximately one fourth and one half of the impeller blades 106 may extend beyond the impeller plate 98. The top of the blades 106 are generally coplanar with the top of the impeller 94 and the impeller 94 may have a generally flat upper surface. The blades 106 are curved so that, when viewed from above or below, the blades curve backwardly relative to the direction of rotation. The inner portion of the blades 106 which is attached to the flat plate 98 may taper towards a reduced height at the inner ends of the blades.

A restrictor plate 110 is placed into the shroud body 38 after the impeller 94 is placed onto the grinder output shaft 30. The shroud body 38 may be made with a groove 114 on the inside which receives the restrictor plate. During assembly, the restrictor plate 110 may be pressed into the groove 114 and be held captive in the groove. The restrictor plate 110 is spaced apart from the impeller 94 in the shroud body so that the impeller 94 does not contact the restrictor plate 110 during operation of the angle grinder 14. The restrictor plate 110 includes an opening 118 which is reduced in size compared to the interior size of the dust collection chamber 48. In the example, the restrictor plate 110 is generally flat and has a circular outside shape. The restrictor plate opening 118 is located at the center of the restrictor plate 110 and is smaller in size than the restrictor place 110 or the inside of the dust collection chamber 48. The outer edge restrictor plate 110 has a round shape to match the round shape of the sidewall 46 and resulting dust collection chamber 48. The restrictor plate opening 118 is also round and is located in the center of the restrictor plate 110. The restrictor plate opening 118 is aligned with the impeller 94 so that the center of the restrictor plate opening 118 is aligned with the center of the impeller 94 and the grinder output shaft 30.

The diameter of the restrictor plate opening 118 is approximately 58 percent of the diameter of the restrictor plate 110 and the area of the restrictor plate opening is approximately 34 percent of the area of the opening in the dust collection chamber 48 where the restrictor plate is located. In another example, the diameter of the restrictor plate opening 118 may be between 45 and 80 percent of the diameter of the restrictor plate (and also the diameter of the opening of the dust collection chamber 48 where the restrictor plate is located) and the area of the restrictor plate opening 118 may be between approximately 20 and 64 percent of the area of the opening in the dust collection chamber 48 where the restrictor plate is located. More preferably, the diameter of the restrictor plate opening 118 may be between 50 and 65 percent of the diameter of the restrictor plate and the area of the restrictor plate opening 118 may be between approximately 25 and 42 percent of the area of the opening in the dust collection chamber 48 where the restrictor plate is located. More preferably, the diameter of the restrictor plate opening 118 may be between 55 and 60 percent of the diameter of the restrictor plate and the area of the restrictor plate opening 118 may be between approximately 30 and 36 percent of the area of the opening in the dust collection chamber 48 where the restrictor plate is located.

After the restrictor plate 110 is installed into the shroud body 38, a grinding or sanding attachment such as the diamond cup wheel 34 may be installed onto the grinder output shaft 30. The bottom end of the grinder output shaft 30 is typically threaded to allow grinding/sanding/cutting attachments to be attached thereto. Some tool attachments such as a sanding disc may be used in combination with a backing plate and may be attached to the output shaft 30 with a separate nut. Other tool attachments such as the diamond cup grinding wheel may have a metal body and may have integral threads for attachment to the output shaft 30. A spacer 92 similar to the spacer 90 may be placed on the output shaft 30 between the impeller 94 and the grinding attachment 34 during assembly to properly locate the grinding attachment relative to the impeller 94 and shroud body 38. The grinding attachment 34 is tightened onto the output shaft 30 and the spacer 92, spacer 90 and impeller 94 are held securely onto the output shaft 30 by the grinding attachment 34. When the grinding attachment 34 is tightened in place, the bottom cutting surface of the grinding attachment 34 is typically located below the plane formed by the bottom edge of the sidewall 46. The bottom cutting surface of the grinding attachment 34 is typically located near or slightly above the plane formed by the bottom edge of the skirt 58. The skirt 58 will typically compress vertically to allow the bottom cutting surface of the grinding attachment 34 to contact desired surface to grind that surface.

In use, the restrictor plate 110 isolates the cutting edge of the grinding attachment 34 from the dust collection chamber 48 and blocks a portion of the airflow channel between the cutting edge of the grinding attachment 34 and the exhaust port 62. The restrictor plate 110 blocks direct access to the outer majority of the impeller blades 106. Air must flow from the cutting edge of the grinding attachment 34 inwardly towards the output shaft 30 and through the central restrictor plate opening 118. From there, the air flows outwardly through the impeller 94 towards the outer periphery of the dust collection chamber 48. The rotation of the impeller 94 and the curved shape of the impeller blades 106 force air outwardly from the center of the impeller 94 towards the sidewall 46 and also cause the air to rotate with the impeller 94. This forces the air out of the exhaust port 62 and into a dust collection system such as a vacuum or a filter.

The restrictor plate 110 directs the airflow through the impeller 94 and, by blocking access to the outer portion of the impeller blades 106, improves the airflow through the impeller 94. The restrictor plate 110 forces air to travel through the impeller blades 106 from center to outer edge and prevents air from partially bypassing the impeller blades 106 by moving upwardly into the outer tips of the impeller blades and out of the exhaust port. The location and design of the restrictor plate 110 improve the pressure generated by the impeller 94 and thereby improve the flow through the impeller 94. The combination of the restrictor plate 110 and the impeller 94 provide sufficient airflow and pressure that, in many instances, the dust collection system 10 may be used without a powered filter such as a vacuum. Instead, the dust collection system 10 may be used with a passive filter such as a filter bag 122 or an extender hose 126 and filter bag 122 attached to the exhaust port 62. This allows the angle grinder 14 and dust collection system 10 to be used in many situations where a lack of available power or physical constraints prevent a powered filter such as a vacuum from being used with the dust collection system 10. Even if a powered filter is used, the restrictor plate 110 and impeller 94 can improve dust collection by directing and improving airflow through the dust collection chamber 48.

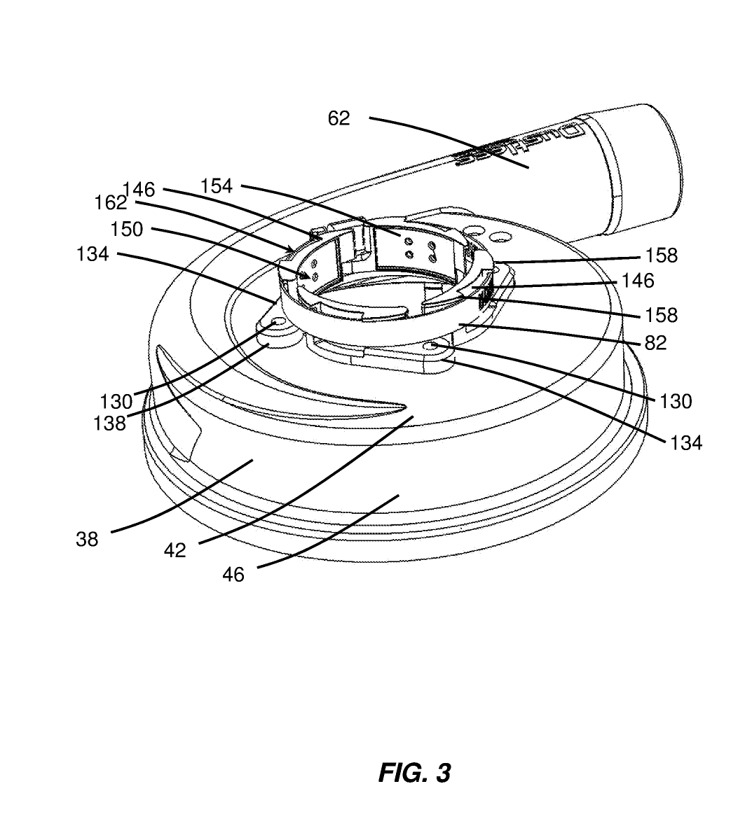

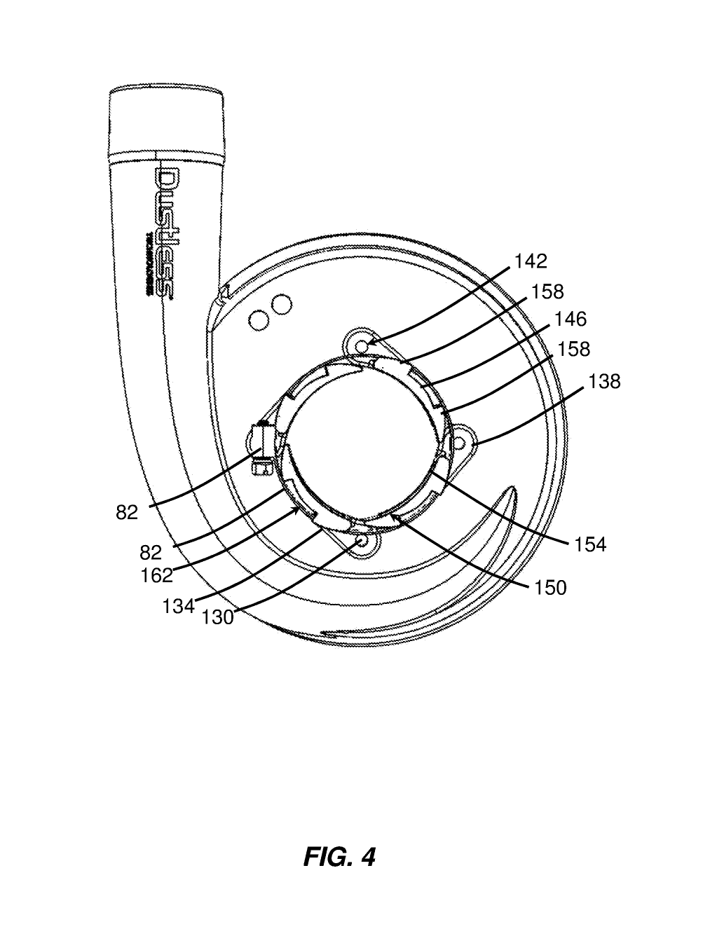

Referring now to FIGS. 3 and 4, a perspective and a top view of the dust collection system 10 are shown. For clarity, the angle grinder 14 is not shown. The dust collection system 10 may include an alternate attachment structure 72 to attach the shroud body 38 to the angle grinder 14. The shroud body 38 is similar to that shown in FIGS. 1A through 2B and, except as noted, includes the same structures. Thus, the dust collection system shown in FIGS. 3 and 4 typically includes an impeller spacer 90, an impeller 94, a restrictor plate 110, a grinding cup spacer 93, and a grinding cup 34. The shroud 38 largely differs in the attachment structure which holds the shroud body to the angle grinder 14.

The attachment structure 72 used to hold the shroud body 38 to the grinder 14 includes clamping arms 134 which attach to the shroud body with pivot posts 130. A number of pivot posts 130 may extend upwardly (vertically) from the upper surface 42 of the shroud body 38. The pivot posts 130 may be formed integrally with the shroud body 38 or may be pins or fasteners attached to the shroud body 38. In the example shroud 38, four pivot posts and clamping arms are used, although 3, 4, 5, or 6 pivot posts and clamping arms may be used. Clamping arms 134 are attached to the pivot posts 130.

Each of the clamping arms 134 may include a pivot boss 138 or a pivoting end with a pivot hole 142. The pivot hole 142 is placed over a pivot post 130 on the shroud body 38 to allow the clamping arm 134 to pivot about the pivot post 130. An arm 146 extends horizontally from the pivot boss 138. The arm 146 may be curved. The inside of the arm 146 is curved to match the curvature of the shoulder 70 on the grinder and the outside of the arm 146 is curved to receive a band clamp. The pivot posts 130 on the grinder body are vertical relative to the grinder body so that the pivot posts 130 are parallel to the output shaft 30 of the angle grinder 14. The clamping arms 134 are shaped such that the mounting/pivoting end 138 of the arm slides on the pivot post 130 and the arm 146 extends away from the mounting end 138 of the arm in a direction which is generally perpendicular to the pivot post 130. The clamping arm 134 rotates about the post 130 so that the clamping arm 146 moves towards and away from the hole through the upper surface 42 of the shroud body. The arm 146 therefore moves towards and away from the shoulder 70 of a grinder 14 as it is pivoted so that it can be secured to the grinder 14.

The curved arm 146 is directed generally towards an adjacent pivot post 130. The curved arm 146 has a curved inside surface 150 which generally matches the curvature of the cylindrical shoulder 70 on the angle grinder 14. The curved inside surface 150 may have/be formed by a pad 154 such as a rubber sheet attached to the inside of the arm 146 to improve the contact and friction between the curved inside surface 150 of the arm 146 and the shoulder 70 of a grinder 14. The outside surface of the clamping arm 134 may also be curved so as to better receive a clamp 82 such as a worm drive clamp. The outside surface of the clamping arm 134 may have ridges 158 adjacent the top and bottom of the clamping arm. The ridges 158 may form a channel which receives the clamp 82 and keeps the clamp properly located on the clamping arms 134. The top ridges 158 may have one or more notches 162 formed therein to accommodate the worm drive portion of the clamp 82.

As seen in FIGS. 3 and 4, an example clamping arm 134 may be formed so that the pivot boss 138 includes a pivot hole 142 and supports the arm 134 and allows the arm to rotate around the pivot pin 130. The clamping arm 134 includes a generally horizontal flange 144 which extends horizontally from the pivot boss 138. A vertical clamping arm 146 extends from the horizontal flange 144. The clamping arm 146 extends horizontally from the flange 144 to continue along the overall length of the clamping arm 134 and also extends vertically from the flange 144 so that multiple of these clamping arms 146 form a collar around the hole through the upper surface 42 of the shroud 38. The clamping arms 146 have an interior surface which is curved in the horizontal dimension and is typically generally straight in a vertical direction so that the interior surface of multiple clamping portions 146 form a generally cylindrical opening which receives a shoulder 70 of a grinder. As discussed, this interior surface 150 may be formed with or lined with an elastomeric material to increase the grip and conformance to the grinder shoulder 70. The outside of the clamping arm 146 is shaped to receive a clamp 82 such as a worm drive clamp and may thus have a rounded shape in a horizontal dimension. A groove may be formed in the clamping arm 146 to receive the clamp 82. The groove may be formed by the ridges 158 and by the horizontal flange 144. This helps to keep the clamp 82 in a desired location on the clamping arm 146 and increases the reliability of the shroud 38.

The curved, semi-cylindrical clamping portions 146 of multiple of the clamping arms 134 together form a generally cylindrical collar, or a collar with a generally cylindrical inner surface which is attached to the shoulder 70 of the grinder 14. The clamping arms 134 may pivot inwardly to reduce the size of the resulting collar and outwardly to increase the size of the resulting collar to allow the shroud body 38 to be mounted to different makes of angle grinders 14. If desired, the ends 162 of the curved arms 146 may be located inside of the pivot bosses 138, or inside of the opposite ends of adjacent mounting arms 134, to prevent the mounting arms 134 from pivoting outwardly beyond the pivot posts 130. This may make it easier for a person to attach the shroud body 38 to an angle grinder.

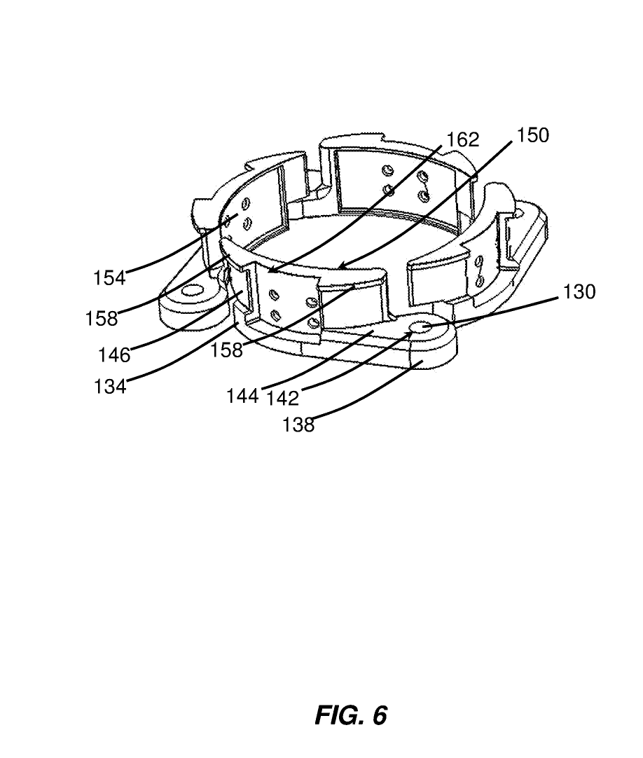

When the mounting arms 134 are connected to a grinder 14 by securing the clamping portions 146 to the grinder shoulder 70 with a clamp 82, the mounting arms 134 are held in a fixed position relative to each other, relative to the shroud body 38, and relative to the grinder 14. This prevents pivoting of the mounting arms 134 relative to the shroud body 38 and holds the shroud body 38 in a fixed position relative to the grinder 14. The shroud body 38 is mounted to the grinder 14 securely and does not experience undue movement during normal use of the grinder 14. FIG. 6 shows a detailed view of the clamping arms 134.

The dust collection system 10 is advantageous as it allows for convenient attachment of a single shroud body and system to a variety of different angle grinders 14. The dust collection system is easily used and is convenient for an operator, promoting compliance in using the dust collection system. The impeller 94 and restrictor plate 110 provide good airflow through the shroud body 38 and allow dust and debris to be removed from the work area and to be collected without requiring use of a powered filter such as a vacuum.

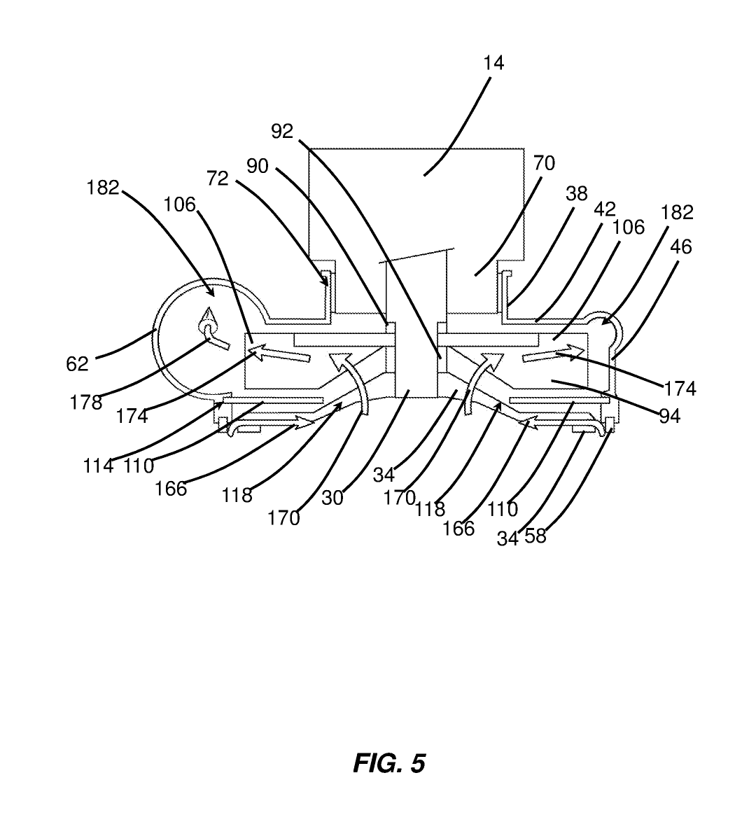

Referring now to FIG. 5, a cross sectional view of the dust collection system 10 is shown. FIG. 5 more particularly illustrates how air may flow through the system 10. During use, air may flow from the work surface being ground above and around the grinding attachment 34 as is shown by arrows 166. Air may also flow from the work surface being ground upwardly through the center of the grinding attachment 34 as shown by arrows 170 where, in some examples, the grinding attachment 34 has holes therethrough adjacent the center of the grinding attachment 34. Air typically flows into the dust collection chamber 48 between bristles or individual segments of the skirt 58 and through any gap between the skirt 58 and the material being ground. Strong air flow will largely prevent grinding dust from moving against the flow of air and out of the dust collection chamber 48.

As is indicated by arrows 166 and 170, air flows towards the center of the dust collection chamber 48 and through the opening 118 in the restrictor plate 110. It can be seen how the restrictor plate 110 divides the dust collection chamber 48 into a lower section which encloses the grinding attachment 34 and an upper section which encloses the impeller 94. In the example, the restrictor plate 110 is a physical barrier which separates the grinding edges of the grinding attachment 34 and the blades 106 of the impeller 94. The restrictor plate 110 and its central opening 118 forces air to move inwardly from the edges of the grinding attachment 34 towards the center of the grinding attachment as this is the only air passage in the dust collection chamber 48 between the lower section surrounding the grinding attachment 34 and the upper section of the dust collection chamber surrounding the impeller 94. Grinding dust tends to move outwardly due to the rotation of the grinding attachment 34. The air flow 166 moves against the motion of the grinding dust and helps to stop the outward movement of the dust. From the central opening 118 of the restrictor plate 110, the air passes into the root of the impeller blades 106. The impeller 94 rotates in a clockwise direction as viewed in FIG. 3 and the left blade 106 in FIG. 5 would rotate into the page. The rotation of the impeller 94 with the grinding attachment 34 forces the air towards the tips of the impeller blades 106 as indicated by arrows 174. The rotation of the impeller 94 also causes the air to rotate with the impeller. As seen in FIG. 3, the example impeller blades 106 are curved into the direction of rotation of the impeller, encouraging the air to rotate with the impeller 94 and maximizing the angular velocity of the rotating air.

As seen in FIGS. 3 and 5, an air flow passage 182 is formed in the dust collection chamber 48. The air flow passage 182 is formed at the shoulder of the dust collection chamber 48 adjacent to the location where the upper surface 42 and sidewall 46 meet. The upper surface 42 and sidewall 46 are positioned relatively closely to the impeller blades 106. The shroud wall section forming the air flow passage 182 is positioned farther away from the impeller blades 106 and the air flow passage 182 provides an increased space between the wall and the impeller blades, providing a space where the air can rotate with the impeller 94. The air flow passage 182 is small or nonexistent immediately after the exhaust port 62 (relative to the rotation of the impeller 94) and gradually increases in dimension along the perimeter of the shroud 38 until the air flow passage 182 reaches a maximum in size near the exhaust port 62 and transitions smoothly into the exhaust port. The alignment of the exhaust port 62 with the tangential movement of the impeller 94 and air flow, as well as the increase in size of the air flow passage 182 towards the exhaust port 62 and the sudden reduction in size of the air flow passage 182 after the exhaust port 62 (relative to the rotation direction of the impeller 94) cause the air to flow out of the exhaust port 62 as indicated by arrow 178.

The dust collection system 10 is advantageous as it provides a functioning dust collection system without requiring a vacuum in addition to the shroud 38. The shroud is compatible with a vacuum and this reduces the filter cleaning requirements, etc., but is functional without the vacuum. The impeller 94, air flow passage 182, and the restrictor plate 110 create strong airflow through the shroud. The airflow through the shroud is sufficient to capture most of the dust created while grinding. Additionally, the impeller 94, the air flow passage 182, and the restrictor plate 110 create sufficient air pressure to maintain air flow through a filter 122.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A dust collection system comprising:
a shroud body having an upper surface and a peripheral sidewall extending downwardly from the upper surface to form a dust collection chamber;
an exhaust port attached to the shroud body, the exhaust port having an opening which is connected to the dust collection chamber;
an impeller;
a restrictor plate having an opening therein;
wherein the restrictor plate is attached to the shroud body and disposed in the dust collection chamber to divide the dust collection chamber into an upper section and a lower section;
wherein the shroud body is attachable to an angle grinder so that an angle grinder output shaft extends into the dust collection chamber, so that the impeller is attached to the angle grinder output shaft, and so that a grinding attachment is attached to the angle grinder output shaft and disposed in the dust collection chamber.

2. The dust collection system of claim 1, wherein the impeller is disposed in the upper section of the dust collection chamber and the grinding attachment is disposed in the lower section of the dust collection chamber.

3. The dust collection system of claim 1, wherein the restrictor plate is disposed between the impeller and the grinding attachment.

4. The dust collection system of claim 3, wherein the impeller includes blades disposed around the outside of an impeller body, and wherein the restrictor plate is disposed between cutting edges of the grinding attachment and the impeller blades.

5. The dust collection system of claim 1, wherein, in use, air flows from the cutting tool inwardly towards the output shaft, upwardly through the restrictor plate opening, outwardly towards the outside of the impeller, and through the exhaust opening.

6. The dust collection system of claim 1, wherein a diameter of the restrictor plate opening is between 45 and 80 percent of a diameter of the restrictor plate;

7. The dust collection system of claim 1, wherein a diameter of the restrictor plate opening is between 50 and 65 percent of a diameter of the restrictor plate.

8. The dust collection system of claim 1, wherein a diameter of the restrictor plate opening is between 55 and 60 percent of a diameter of the restrictor plate.

9. The dust collection system of claim 1, wherein the shroud body is attached to a shoulder on the tool surrounding the output shaft by an attachment structure comprising:
a plurality of curved clamping arms having a first end pivotably attached to the upper surface of the shroud body, each of the clamping arms having a curved inner surface which contacts the output shaft; and
a clamp disposed around the clamping arms and holding the clamping arms against the shoulder.

10. The dust collection system of claim 1, wherein the shroud body includes an opening in the upper surface of the shroud body, and wherein the shroud body is attached to a grinder by an attachment structure comprising:
a plurality of pivot posts extending upwardly from the upper surface of the shroud body;
a plurality of clamping arms corresponding to the plurality of pivot posts, each of the clamping arms comprising a first end having a hole therein which receives the pivot post; an arm extending laterally from the first end, and a clamping portion attached to the arm, and wherein the clamping arm is pivotable about the pivot post to move the clamping portion closer to or farther away from the opening in the shroud body.

11. The dust collection system of claim 10, further comprising a clamp which extends around the clamping portions of the plurality of clamping arms to hold the clamping portions against a grinder.

12. The dust collection system of claim 11, wherein the clamping portion of the clamping arms includes a groove which receives the clamp.

13. The dust collection system of claim 10, further comprising an elastomeric material on the inside of the clamping portions.

14. The dust collection system of claim 10, wherein a generally cylindrical opening is formed between inside surfaces of the clamping portions of the clamping arms.

15. A dust collection system comprising:
a shroud body having an upper surface and a peripheral sidewall extending downwardly from the upper surface to form a dust collection chamber;
an exhaust port attached to the shroud body, the exhaust port having an opening which is connected to the dust collection chamber;
an opening in the upper surface of the shroud body; and
an attachment structure comprising:
a plurality of pivot posts extending upwardly from the upper surface of the shroud body;
a plurality of clamping arms rotatably attached to the plurality of pivot posts, each of the clamping arms comprising a first end having a hole therein which receives the pivot post; an arm extending laterally from the first end, and a clamping portion, and wherein the clamping arm is pivotable about the pivot post to move the clamping portion closer to or farther away from the opening in the shroud body.

16. The dust collection system of claim 15, wherein a generally cylindrical opening is formed between inside surfaces of the clamping portions of the clamping arms.

17. The dust collection system of claim 15, wherein the pivot posts are positioned uniformly around the opening.

18. The dust collection of claim 15, further comprising:
an impeller;
a restrictor plate having an opening therein;
wherein the restrictor plate is attached to the shroud body and disposed in the dust collection chamber to divide the dust collection chamber into an upper section and a lower section;
wherein the shroud body is attachable to a rotary tool so that a output shaft of the rotary tool extends into the dust collection chamber, so that the impeller is attached to the output shaft and disposed in the upper section of the dust collection chamber, and so that a grinding attachment is attached to the angle grinder output shaft and disposed in the lower section of the dust collection chamber.

19. The dust collection system of claim 18, wherein a diameter of the restrictor plate opening is between 50 and 65 percent of a diameter of the dust collection chamber.

20. The dust collection system of claim 18, wherein, in use, air flows from the cutting tool inwardly towards the output shaft, upwardly through the restrictor plate opening, outwardly towards the outside of the impeller, and through the exhaust opening.
